(19) United States
(12) Patent Application Publication
(10) Pub. No.: US 2012/0262622 A1
(43) Pub. Date: Oct. 18, 2012

(54) IMAGE SENSOR, IMAGE PROCESSING APPARATUS AND MANUFACTURING METHOD

(75) Inventors: Yi Tae Kim, Hwaseong-si (KR); Sung-Ho Choi, Seoul (KR)

(73) Assignee: SAMSUNG ELECTRONICS CO., LTD., SUWON-SI (KR)

(21) Appl. No.: 13/445,014

(22) Filed: Apr. 12, 2012

(30) Foreign Application Priority Data
Apr. 18, 2011 (KR) 10-2011-0035853

(51) Int. Cl. H04N 5/225; H01L 31/0224

(52) U.S. Cl. 348/340; 257/291; 438/73; 257/E31.124

(57) ABSTRACT

An image sensor includes first pixels in an active region and second pixels in an optical black region of a pixel array. The first pixels have a gate that receives an active transfer control signal, and the second pixels have a gate that receives a passive transfer control signal, like a ground voltage.

### CROSS-REFERENCE TO RELATED APPLICATIONS

This application claims priority under 35 U.S.C. §119(a) from Korean Patent Application No. 10-2011-0035853 filed on Apr. 18, 2011, the subject matter of which is hereby incorporated by reference.

### BACKGROUND OF THE INVENTION

Embodiments of inventive concepts relate to image sensors and image processing apparatuses incorporating image sensors, as well as related methods of manufacture. More particularly, embodiments of the inventive concept relate to image sensors using a transfer control signal that effectively reduces or eliminates the horizontal noise that is present in an output signal provided by conventional image sensors.

A complementary metal-oxide semiconductor (CMOS) image sensor includes an optical black pixel (OB pixel) in an optical black region of a pixel array that is used to measure dark current. The OB pixel includes a transfer transistor controlled by a transfer control signal applied to the gate of the transfer transistor. When the transfer control signal turns ON the transfer transistor, an electrical charge accumulated in a photodiode (PD) of the OB pixel is transferred to an output of the OB pixel. Unfortunately, the use of an active transfer control signal in conjunction with the transfer transistor operation within a OB pixel generates so-called “horizontal noise”, a type of fixed pattern noise. The presence of horizontal noise on the output signal provided by the OB pixel degrades the OB pixel's ability to accurately indicate dark current.

### SUMMARY OF THE INVENTION

In one embodiment, the inventive concept provides an image sensor including; a plurality of first pixels disposed in an active region of a pixel array, and a plurality of second pixels disposed in an optical black region of the pixel array. Each of the plurality of first pixels includes a first transfer transistor disposed between a first photoelectric conversion element and a first floating diffusion region and having a gate that receives an active transfer control signal. Each of the plurality of second pixels includes a second transfer transistor disposed between a second photoelectric conversion element and a second floating diffusion region and having a gate that receives a passive transfer control signal.

In another embodiment, the inventive concept provides an image processing apparatus including; a processor that controls operation of an image sensor. The image sensor includes; a plurality of first pixels disposed in an active region of a pixel array, and a plurality of second pixels disposed in an optical black region of the pixel array. Each of the plurality of first pixels includes a first transfer transistor disposed between a first photoelectric conversion element and a first floating diffusion region and having a gate that receives an active transfer control signal, and each of the plurality of second pixels includes a second transfer transistor disposed between a second photoelectric conversion element and a second floating diffusion region and having a gate that receives a passive transfer control signal.

In another embodiment, the inventive concept provides a method of manufacturing an image sensor. The method includes; fabricating first pixels in an active region of a pixel array by forming a first photoelectric conversion element in the active region, forming a first floating diffusion region in the active region, forming a first transfer transistor between the first photoelectric conversion element to the first floating diffusion region, and connecting a gate of the first transfer transistor to an active transfer control signal line for supplying an active transfer control signal. The method further includes; fabricating second pixels in an optical black region of the pixel array by forming a second photoelectric conversion element in the optical black region, forming a second floating diffusion region in the optical black region, forming a second transfer transistor between the second photoelectric conversion element to the second floating diffusion region, and connecting a gate of the second transfer transistor to a passive transfer control signal line for supplying a passive transfer control signal.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram illustrating an image sensor according to an embodiment of the inventive concept;

FIG. 2 is a circuit diagram further illustrating one possible embodiment of the first pixel shown in FIG. 1;

FIG. 3 is a circuit diagram further illustrating one possible embodiment of the second pixel shown in FIG. 1;

FIG. 4 is a circuit diagram further illustrating another possible embodiment of the second pixel shown in FIG. 1;

FIG. 5 is a block diagram illustrating an image processing apparatus including the image sensor shown in FIG. 1;

FIG. 6 is a general block diagram illustrating an electronic system with constituent interfaces that may incorporate the image sensor shown in FIG. 1; and

FIG. 7 is a flow chart summarizing one possible method of manufacture for an image sensor or an image processing apparatus including an image sensor according to an embodiment of the inventive concept.

### DETAILED DESCRIPTION

Embodiments of the inventive concept will now be described in some additional detail with reference to the accompanying drawings. This inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings, like reference numbers and labels refer to like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

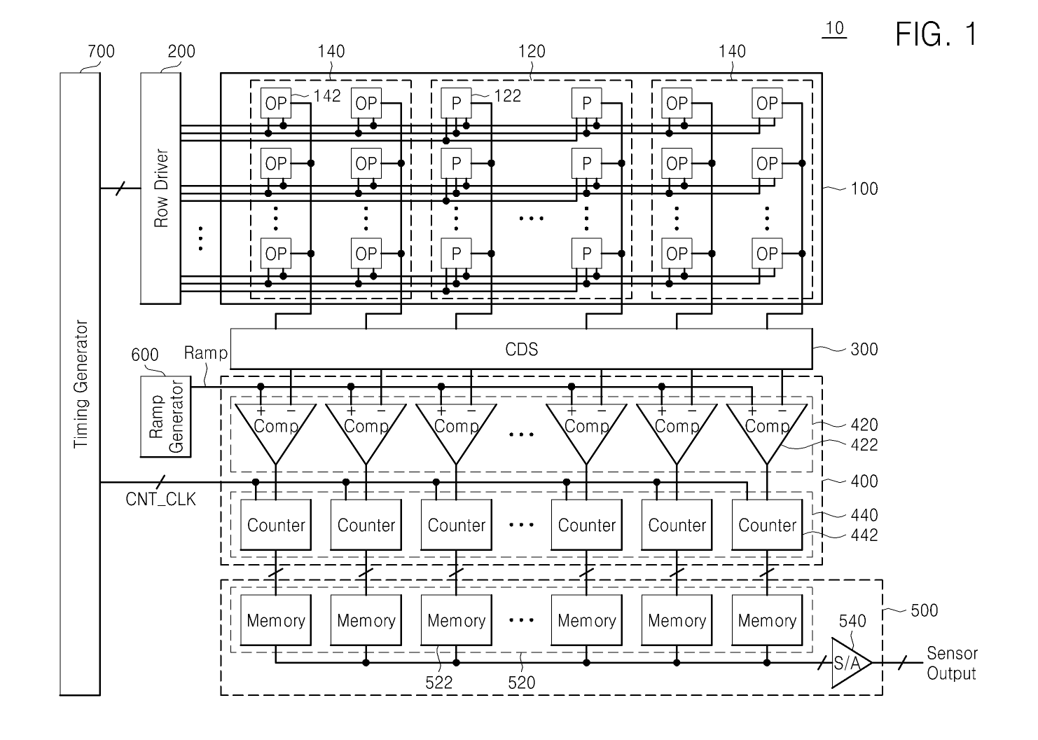

Figure (FIG. 1 is a block diagram illustrating an image sensor according to an embodiment of the inventive concept. Referring to FIG. 1, an image sensor 10 (e.g., a CMOS image sensor) comprises; a pixel array 100, a row driver 200, a correlated double sampling (CDS) block 300, an analog-to-digital converter (ADC) 400, a buffer 500, a ramp signal generator 600, and a timing generator 700.

The pixel array 100 includes a plurality of first pixels (P) 122 located in an active region 120 and a plurality of second pixels (OP) 142 located in an optical black region 140. Each of the plurality of first pixels 122 includes a red pixel that converts light in a red spectrum into a corresponding electrical signal, a green pixel that converts light in a green spectrum into a corresponding electrical signal, and a blue pixel that converts light in a blue spectrum into a corresponding electrical signal.

A color filter array is typically placed over each of the first pixels 122 to transmit (or “pass”) light in a specific spectrum (or light having a defined range of optical wavelengths).

As shown in FIG. 1, separate optical black regions 140 may be disposed on either side of the active region 120. Other embodiments will incorporate on a single optical black region 140 disposed to one side of the active region 120.

The row driver 200 generates a plurality of control signals that control an optical sensing operation within each of the first pixels 122 and second pixels 142 under the control of the timing generator 700. The row driver 200 may be configured to drive the pixels on a row by row basis (or in row units).

The CDS block 300 performs a correlated double sampling (CDS) with respect to each of the signals output from the pixel array 100 in response to control signals output from the timing generator 700. The ADC 400 performs an analog-digital conversion with respect to the signals having undergone the CDS and output corresponding digital signals. The ADC 400 shown in FIG. 1 includes a comparison block 420 and a counter block 440.

The comparison block 420 includes a plurality of comparators (Comp) 422. Each of the comparators 422 is respectively connected to the CDS block 300 and the ramp signal generator 600. That is, the CDS block 300 is respectively connected to a first input terminal of each one of the comparators 422, and the ramp signal generator 600 is respectively connected to a second input terminal of the comparators 422.

With this connection configuration, each comparator 422 receives an output signal from the CDS block 300 and a ramp signal Ramp from the ramp signal generator 600, and compares the output signal of the CDS block 300 with the ramp signal Ramp to generate a comparison signal. The comparison result signal thus provided by each comparator 422 expresses a difference value between an image signal that varies with luminance (i.e., the brightness of an optical image signal generating the image signal) and a reset signal.

The ramp signal Ramp may be effectively used to generate the difference value between the image signal and the reset signal, since the difference value may be readily identified and output according to the slope of the ramp signal Ramp. The ramp signal generator 600 operates in response to one or more control signal(s) provided by the timing generator 700.

The counter block 440 includes a plurality of counters 442. Each of the counters 442 is connected to an output terminal of a corresponding comparator 422 among the plurality of comparators 422. Each of the counters 442 counts the comparison result in response to a clock CNT-CLK applied from the timing generator 700 in order to generate a digital signal corresponding to the comparison result. The clock CNT_CLK may be provided by a counter controller (not shown) located inside the counter block 440, or by the timing generator 700.

Each counter 442 may include an up/down counter and a bit-wise inversion counter. The bit-wise inversion counter performs an operation similar to an operation of the up/down counter. For example, the bit-wise counter may perform an up counting and a function of inverting all the bits inside the counter and making them l′s complement, when a specific signal is input. Thus, a reset count is performed using this combination of functions (i.e., bit inversion and 1′ complement conversion) to yield a negative value.

The buffer 500 includes a column memory block 520 and a sense amplifier 540, and the column memory block 520 includes a plurality of memories 522. The plurality of memories 522 operates according to a memory control signal generated by a memory controller (not shown) located inside the column memory block 520 or inside the timing generator 700, based on the control signal generated from the timing generator 700. Each of the memories 522 may be implemented as a static random access memory (SRAM). The column memory block 520 temporarily stores the digital signal that is output by the plurality of counters 442 and outputs the digital signal to a sense amplifier 540 according to the memory control signal. And, the sense amplifier 540 senses the digital signals, amplifies, and outputs the same.

The timing generator 700 outputs control signals that control the respective operation and inter-operation between the row driver 200, the CDS block 300, and the ramp signal generator 600.

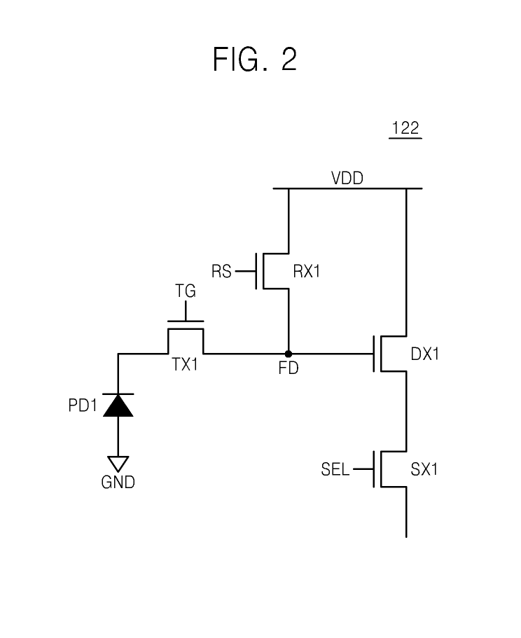

FIG. 2 is a circuit diagram further illustrating in one possible embodiment the first pixel 122 shown in FIG. 1. The first pixel 122 includes a first photoelectric conversion element PD1, a first transfer transistor TX1, a first reset transistor RX1, a first drive transistor DX1, and a first select transistor SX1.

The first photoelectric conversion element PD1 generates photo-generated electrical charge in response to incident light received by the first pixel 122. The first photoelectric conversion element PD1 may be implemented using a photo diode, a pinned photo diode, or the like.

The first transfer transistor TX1 transfers the photo-generated charge accumulated by the first photoelectric conversion element PD1 to a floating diffusion region FD in response to a first transfer control signal TG. The photo-generated charge is transferred when the first transfer transistor TX1 is turned ON, thereby allowing the photo-generated charge to be stored by the floating diffusion region FD.

The first reset transistor RX1 resets a voltage level of the floating diffusion region FD to the level of a supply voltage VDD. The first drive transistor DX1 outputs an electrical signal proportional to the amount of the photo-generated charge transferred from the floating diffusion region FD.

The first select transistor SX1 outputs an output signal of the first drive transistor DX1 into the correlated double sampling block 300 in response to a select signal SEL. The first transfer control signal TG, the reset signal RS, and the select signal SEL may be generated by the row driver 200.

The first transfer transistor TX1, the first reset transistor RX1, the first drive transistor DX1, and the first select transistor SX1 shown in FIG. 2 are implemented as respective NMOS transistors, but in other embodiments may be respective PMOS transistors.

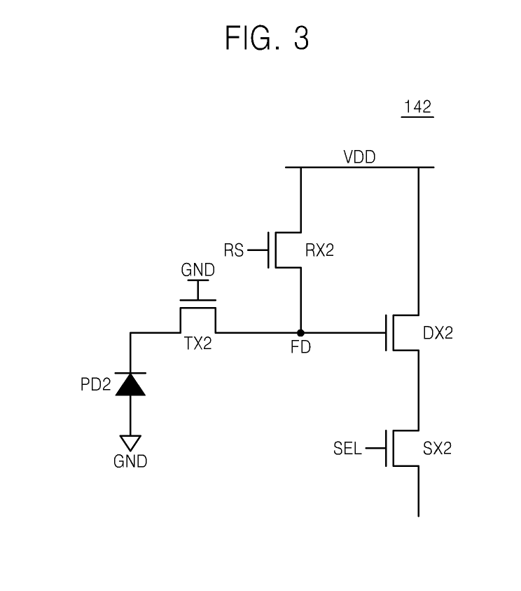

FIG. 3 is a circuit diagram illustrating one possible embodiment for the second pixel shown in FIG. 1. The second pixel 142 includes a second transfer transistor TX2, a second reset transistor RX2, a second drive transistor DX2, and a second select transistor SX2. The second pixel 142 further includes a second photoelectric conversion element PD2.

The second photoelectric conversion element PD2 generates photo-generated charge corresponding to incident light received by the second pixel 142. The second photoelectric conversion element PD2 may be implemented using a photo diode, a pinned photo diode, or the like.

The second transfer transistor TX2 transfers photo-generated charge accumulated by the second photoelectric conversion element PD2 to a floating diffusion region FD in response to a second transfer control signal. The photo-generated charge are transferred when the second transfer transistor TX2 is turned ON in order to store the photo-generated charge in the floating diffusion region FD.

The second transfer transistor TX2 may be turned OFF in response to the second transfer control signal. That is, the second transfer control signal may be designed to have a voltage level that turns OFF the second transfer transistor TX2. For example, the second transfer transistor TX2 may be implemented using an NMOS transistor, such that a ground voltage GND provided to the gate of the second transfer transistor TX2 as the second transfer control signal causes the second transfer transistor TX2 to turn ON and pass the photo-generated charge to the floating diffusion region FD.

By way of comparison with the first pixel 122 previously with reference to FIG. 2 that is turned ON by an active (first) transfer control signal TG, the second pixel 142 of FIG. 3 receives a passive (second) transfer control signal (e.g., GND). As a result, the horizontal noise that may be induced by the active switching of the first transfer control signal TG from (e.g.,) a logical low state to a logical high state may be eliminated from the image output signal provided by the second pixel 142.

Further in this regard, the second pixel 142 may be implemented with a metal layer or region that effectively blocks incident light. For example, a metal layer or region formed from Au, Ag, Cu, Al, etc., may be used.

In conventional image sensors, the operation of the second transfer transistor TX2 is controlled by a control signal having signal properties (i.e., active high/low toggling) that are the same as the control signal applied to the first transfer transistor TX1. However, as noted above, the periodic toggling (i.e., the active nature) of the transfer control signal may induce a significant amount of noise within the image output signal provided by the second pixel 142. Accordingly, the image sensor 10 of FIG. 1 according to an embodiment of the inventive concept applies a passive second transfer control signal to the second transfer transistor TX2. A “passive” transfer control signal applies a direct current (DC) voltage level (such as ground) to the second transfer transistor TX2, unlike the active transfer control signal used to turn ON (or activate) the first transfer transistor TX1. As a result, any photo-generated charge provided by the second photoelectric conversion element PD2 will not be transferred to the floating diffusion region FD, and horizontal noise will not be included within the image output signal of the second pixel 142 within the image sensor 10.

Otherwise, the second reset transistor RX2 may be used to reset the voltage level of the floating diffusion region FD to the level of the supply voltage VDD in response to a reset signal RS. The second drive transistor DX2 may be used to output an electrical signal that varies proportionally with the amount of the photo-generated charge apparent at the floating diffusion region FD. The second select transistor SX2 may be used to provide an image output signal provided by the second drive transistor DX2 to the correlated double sampling block 300 in response to a select signal SEL. The reset signal RS and the select signal SEL may be generated by the row driver 200.

Hence, the second pixel 142 may be structurally configured and operated in exactly the same manner as the first pixel 122, except for the control signal applied to the second transfer transistor TX2 of the second pixel 142. As a result, the second pixel 142 is able to provide a signal that exactly corresponds to a level of noise caused by electrical signals generated during the operation of the second pixel 142. Thereafter, the CDS block 300 may be used to remove the noise component apparent in a first image output signal provided by a first pixel 122 using a second image output signal provided by the second pixel 142.

Those of ordinary skill in the art will appreciate the design, layout and fabrication simplicity afforded by the foregoing embodiment. That is, whereas each first and second pixel may be implemented using exactly the same number and type of constituent components, the resulting second pixels are much better suited for their intended purpose than the second pixels provided by the conventional image sensors.

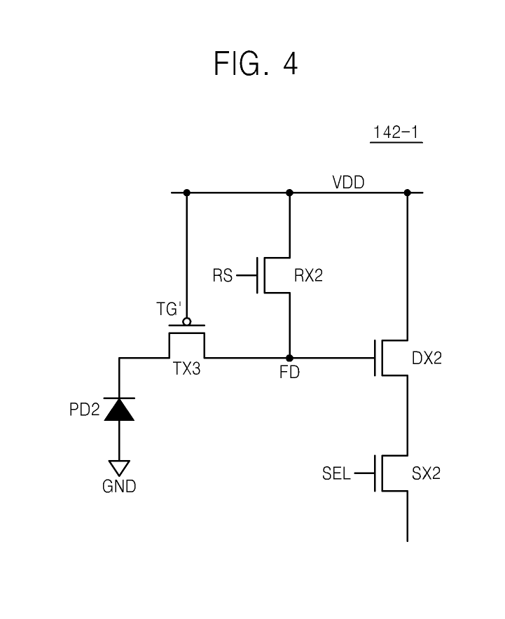

FIG. 4 is a circuit diagram illustrating of another possible embodiment for the second pixel shown in FIG. 1. Referring to FIG. 4, the second pixel 142-1 includes a second photoelectric conversion element PD2, a second transfer transistor TX3, a second reset transistor RX2, a second drive transistor DX2, and a second select transistor SX2. Redundant descriptions relative to similar components between the second pixel 142 of FIG. 3 on the second pixel 142-1 of FIG. 4 will be omitted.

The second transfer transistor TX3 transfers photo-generated charges accumulated on the second photoelectric conversion element PD2 to a floating diffusion region FD in response to a second transfer control signal TG′. The photo-generated charges are transferred when the second transfer transistor TX3 is turned ON to store the photo-generated charge in the floating diffusion region FD.

However, like the second transfer transistor TX2 previously described, the second transfer transistor TX3 is turned OFF in response to the second transfer control signal. That is, the second transfer control signal TG′ will be passive in nature (i.e., have a DC level) and may be used to turn OFF the second transfer transistor TX3. The second transfer transistor TX3 is implemented using a PMOS transistor, and a supply voltage VDD may be provided to the gate of the second transfer transistor TX3 as the second transfer control signal TG′.

The second reset transistor RX2, the second drive transistor DX2, and the second select transistor SX2 shown in FIG. 3 or FIG. 4 may be implemented as respective NMOS transistors. However, each of the second reset transistor RX2, the second drive transistor DX2, and the second select transistor SX2 may be implemented as respective PMOS transistors in other embodiments.

As described above, each of the plurality of second pixels OP included in the image sensor 10 according to an embodiment of the inventive concept does not generate an optical black signal having a dark level. Thus, the image sensor 10 may further include a plurality of optical black (OB) pixels to generate the optical black signal. The plurality of optical black pixels may be located in an upper portion or a lower portion of the pixel array 100, or to one side of the pixel array 100.

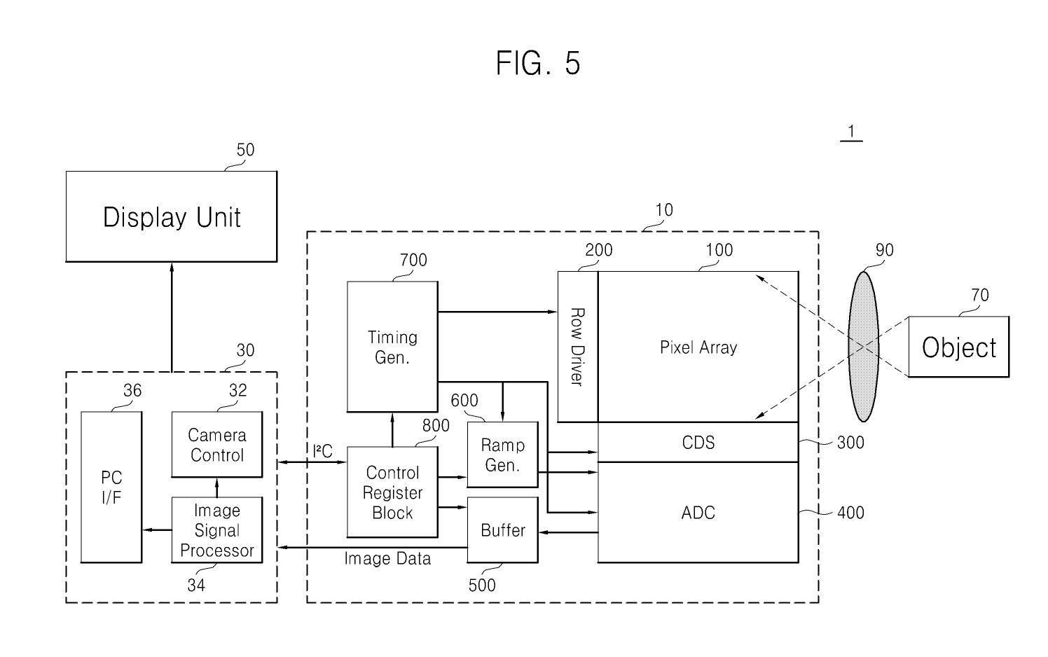

FIG. 5 is a block diagram of an image processing apparatus incorporating the image sensor shown in FIG. 1. Referring to FIG. 5, an image processing apparatus 1 comprises; the image sensor 10, an optical lens 90, a digital signal processor (DSP) 30, and a display unit 50.

The image processing apparatus 1 includes a digital camera and a data processing system including the digital camera, for example, a personal computer (PC), a mobile phone, a smart phone, a tablet PC, or an information-technology (IT) device. The digital camera may be a digital single-lens reflex (DSLR) camera.

The image sensor 10 converts an optical image signal of an object 70 input through the optical lens 90 into an electric image data under the control of the image processor 30. The image sensor 10 may further include a control register block 800. The control register block 800 outputs a control signal to control an operation of a ramp signal generator 600, a timing generator 700, and a buffer 500, respectively. The operation of the control register block 800 may be controlled by a camera control 32.

The image processor 30 controls an operation of the image sensor 10, processes image data output from the image sensor 10, and transfers the processed image data to the display unit 50 for displaying. The image data is generated according to an output signal of the buffer 500. The display unit 50 includes any types of apparatus capable of outputting an image, for example, a PC, a mobile phone, an image output terminal, or the like.

The image processor 30 includes a camera controller 32, an image signal processor 34, and a PC I/F (PC Interface) 36.

The camera controller 32 controls the control register block 800. The camera controller 32 controls the image sensor 10. That is, the image sensor is controlled by the register block 800 using an inter-integrated circuit (I²C) in the illustrated example of FIG. 5. However, other embodiment are not restricted to this approach.

The image signal processor 34 receives the image data which is an output signal of the buffer 500, processes the image data, and outputs the processed image data to the display unit 50 through the PC I/F 36.

The image signal processor 34 shown in FIG. 5 is included in the DSP 30. However, the image signal processor 34 may be included in the image sensor 10 in certain embodiments. That is, the image sensor 10 and the image signal processor 34 may be implemented within a single chip.

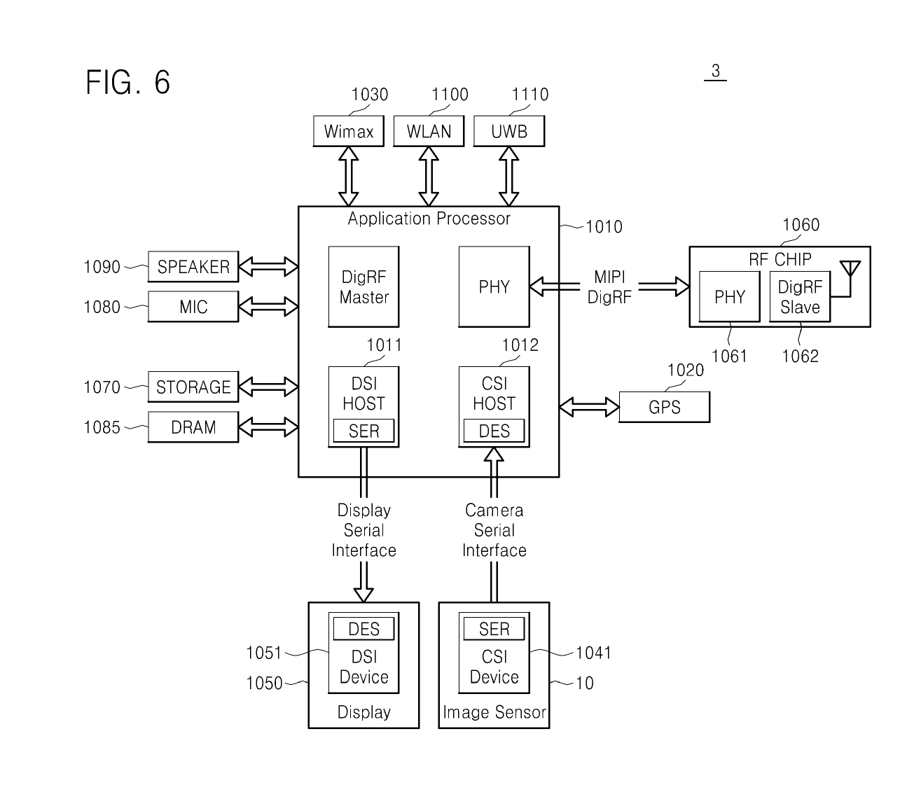

FIG. 6 illustrates an electronic system and related interfaces capable of including an image sensor like the one shown in FIG. 1. Referring to FIG. 6, the electronic system 3 may be implemented as a data processing apparatus capable of using or supporting an MIPI® (Mobile Industry Processor Interface), for example, a mobile phone, a personal digital assistant (PDA), a portable multimedia player (PMP), or a smart phone.

The electronic system 3 includes an application processor 1010, the image sensor 10, and a display 1050. A CSI host 1012 embodied on the application processor 1010 performs a serial communication with a CSI device 1041 of the image sensor 10 through a camera serial interface (CSI). An optical deserializer may be provide by the CSI host 1012 and an optical serializer may be provided by the CSI device 1041.

A DSI host 1011 provided by the application processor 1010 may be used to perform a serial communication operation with a DSI device 1051 of the display 1050 through a display serial interface (DSI). An optical serializer may be provide by the DSI host 1011 and an optical deserializer may be provide by the DSI apparatus 1051.

The electronic system 3 may further include an RF chip 1060 capable of communicating with the application processor 1010. A PHY 1013 of the electronic system 3 and a PHY 1061 of the RF chip 1060 exchanges a data according to a MIPI Dig RF.

The electronic system 3 may further include a global positioning system (GPS) 1020, a storage 1070, a microphone 1080, a dynamic random access memory (DRAM) 1085, and a speaker 1090. In addition, the electronic system 3 may communicate by using world interoperability of microwave access (Wimax) 1030, wireless LAN (WLAN) 1100, ultra wideband (UWB) 1110, and the like.

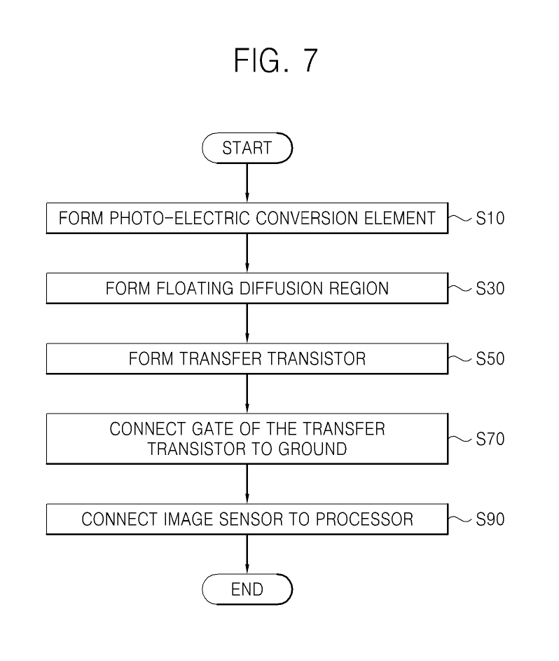

FIG. 7 is a flow chart summarizing one possible method of manufacturing an image sensor and an image processing apparatus including the image sensor according to an embodiment of the inventive concept. Referring to FIG. 7, the method of manufactures presupposes that all first pixels 122 of FIG. 1 are fabricated according to conventionally understood methods, but all second pixels 142 are fabricated according to the method set forth in FIG. 7. It should be noted that many of the fabrication steps set forth in FIG. 7 may also be simultaneously used to fabricate the first pixels and second pixels within the image sensor.

The method of manufacture summarized in FIG. 7 includes forming a photoelectric conversion element in an optical black region (S10); forming a floating diffusion region is formed in the optical black region (S30); and forming a transfer transistor to transfer photo-generated charge generated by the photoelectric conversion element to the floating diffusion region (S50). Then, if the transfer transistor is intended to operate as a second transfer transistor, its gate is connected to a DC voltage source, such as ground (S70). Then, the image sensor is connected to a processor controlling its operation (S90).

An image sensor according to an embodiment of the inventive concept may be used to effectively remove horizontal noise from an image output signal.

While the present inventive concept has been particularly shown and described with reference to exemplary embodiments thereof, it will be understood that various changes in form and details may be made therein without departing from the scope of the following claims.

What is claimed is:

1. An image sensor comprising:
a plurality of first pixels disposed in an active region of a pixel array; and
a plurality of second pixels disposed in an optical black region of the pixel array,
wherein each of the plurality of first pixels includes a first transfer transistor disposed between a first photoelectric conversion element and a first floating diffusion region and having a gate that receives an active transfer control signal, and each of the plurality of second pixels includes a second transfer transistor disposed between a second photoelectric conversion element and a second floating diffusion region and having a gate that receives a passive transfer control signal.

2. The image sensor of claim 1, wherein the active transfer signal has a voltage level that periodically changes, and the passive transfer control signal has a direct current (DC) voltage.

3. The image sensor of claim 2, wherein the DC voltage is ground voltage.

4. The image sensor of claim 3, wherein the first and second transfer transistors are each an N-type metal-oxide semiconductor (NMOS) transistor.

5. The image sensor of claim 2, wherein the first transfer transistor is an N-type metal-oxide semiconductor (NMOS) transistor, the second transfer transistor is a P-type metal-oxide semiconductor (PMOS) transistor, and the second transfer control signal is a supply voltage.

6. The image sensor of claim 1, wherein the optical black region includes a first optical black region disposed to one side of the active region, and a second optical black region disposed to another side of the active region.

7. An image processing apparatus comprising:
a processor that controls operation of an image sensor, wherein the image sensor comprises:
a plurality of first pixels disposed in an active region of a pixel array; and
a plurality of second pixels disposed in an optical black region of the pixel array,
wherein each of the plurality of first pixels includes a first transfer transistor disposed between a first photoelectric conversion element and a first floating diffusion region and having a gate that receives an active transfer control signal, and each of the plurality of second pixels includes a second transfer transistor disposed between a second photoelectric conversion element and a second floating diffusion region and having a gate that receives a passive transfer control signal.

8. The image processing apparatus of claim 7, wherein the active transfer signal has a voltage level that periodically changes, and the passive transfer control signal has a direct current (DC) voltage.

9. The image processing apparatus of claim 8, wherein the DC voltage is ground voltage.

10. The image processing apparatus of claim 9, wherein the first and second transfer transistors are each an N-type metal-oxide semiconductor (NMOS) transistor.

11. The image processing apparatus of claim 8, wherein the first transfer transistor is an N-type metal-oxide semiconductor (NMOS) transistor, the second transfer transistor is a P-type metal-oxide semiconductor (PMOS) transistor, and the second transfer control signal is a supply voltage.

12. The image processing apparatus of claim 7, wherein the optical black region includes a first optical black region disposed to one side of the active region, and a second optical black region disposed to another side of the active region.

13. The image processing apparatus of claim 7, wherein the image processing apparatus is a digital single-lens reflex (DSLR) camera.

14. A method of manufacturing an image sensor, the method comprising:
fabricating first pixels in an active region of a pixel array by;
forming a first photoelectric conversion element in the active region,
forming a first floating diffusion region in the active region,
forming a first transfer transistor between the first photoelectric conversion element to the first floating diffusion region, and
connecting a gate of the first transfer transistor to an active transfer control signal line for supplying an active transfer control signal; and
fabricating second pixels in an optical black region of the pixel array by:
forming a second photoelectric conversion element in the optical black region,
forming a second floating diffusion region in the optical black region,
forming a second transfer transistor between the second photoelectric conversion element to the second floating diffusion region, and
connecting a gate of the second transfer transistor to a passive transfer control signal line for supplying a passive transfer control signal.

15. The method of claim 14, wherein the active transfer signal has a voltage level that periodically changes, and the passive transfer control signal has a direct current (DC) voltage.

16. The method of claim 15, wherein the DC voltage is ground voltage.

17. The method of claim 16, wherein the first and second transfer transistors are each an N-type metal-oxide semiconductor (NMOS) transistor.

18. The method of claim 17, wherein forming the first photoelectric conversion element in the active region and forming the second photoelectric conversion element in the optical black region are simultaneously performed,
forming the first floating diffusion region in the active region and forming the second floating diffusion region in the optical black region are simultaneously performed, and
forming the first transfer transistor between the first photoelectric conversion element to the first floating diffusion region and forming the second transfer transistor between the second photoelectric conversion element to the second floating diffusion region are simultaneously performed.

19. The method of claim 15, wherein the first transfer transistor is an N-type metal-oxide semiconductor (NMOS) transistor, the second transfer transistor is a P-type metal-oxide semiconductor (PMOS) transistor, and the second transfer control signal is a supply voltage.

20. The method of claim 14, wherein the optical black region includes a first optical black region disposed to one side of the active region, and a second optical black region disposed to another side of the active region.
